(19) United States
(12) Patent Application Publication
(10) Pub. No.: US 2003/0095671 A1
(43) Pub. Date: May 22, 2003

(54) Method and apparatus for transporting audio equipment

(75) Inventor: Dong Qing Long, Xixiang Town (CN)

Correspondence Address: MERCHANT & GOULD PC, P.O. BOX 2903, MINNEAPOLIS, MN, 55402-0903, US

(73) Assignee: IAG Limited

(21) Appl. No.: 09/990,555

(22) Filed: Nov. 21, 2001

(51) Int. Cl. H04R 1/02; H04R 9/06

(52) U.S. Cl. 381/87; 381/334; 381/332

(57) ABSTRACT

An attached audio equipment system having attachment mechanisms and locating components. The attachment mechanisms and locating components being integral with the audio equipment to provide an improved transportable audio equipment system.

### FIELD OF THE INVENTION

This invention is related to a method and apparatus for transporting audio equipment together for transport. Particularly, this invention is related to a method and apparatus including attachment and locating mechanisms in an improved system for attachment and transporting of audio equipment

### BACKGROUND OF THE INVENTION

Audio equipment and sound systems have been widely used and are well known. Particularly, people, both professionals and the less experienced, use this equipment for entertainment and performance purposes. In the past, this equipment has been stored and transported using a variety of additional parts, such as rack cases, covers, bags and boxes. Further, a dolly or other such wheeled platforms have been needed to transport this equipment. However, the need for additional parts and vehicles for transporting are inconvenient and may include additional costs. Such additional parts may become lost or damaged thereby needing replacement. Further, employing wheeled platforms may not provide optimum security and protection when transporting the equipment, as equipment may fall or slide off.

Therefore, there is a need for an improved way and a cost effective assembly for securing and protecting such audio equipment during transport or storage.

### SUMMARY OF THE INVENTION

In accordance with the present invention, the above and other problems were solved by providing a method and apparatus for attaching audio equipment in an improved system for transport.

In one embodiment of the present invention, an apparatus for transporting audio equipment includes a plurality of audio components. The audio components each may have at least one attachment mechanism, such that the attachment mechanism may be integral with each audio component. At least one of the audio components includes at least one handle associated thereon and integrally formed on the audio component. At least one of the audio components may include a wheel assembly associated thereon and integral with the audio component. The attachment mechanisms, handle, and wheel assembly may allow the audio components to stack in a vertical orientation and be transported as a single unit in an attached configuration.

In one embodiment of the present invention, an apparatus for transporting audio equipment includes a control unit, a first speaker unit and a bottom speaker unit. The control unit may have a handle attached on the control unit. The control unit may include an attachment mechanism. The first speaker may include a first attachment mechanism and a second attachment mechanism. The bottom speaker unit may include an attachment mechanism. Attachment mechanism of the control unit may engage and releasably lock with the first attachment mechanism of the first speaker unit, and the second attachment mechanism of the first speaker unit may engage and releasably lock with the attachment mechanism of the bottom speaker unit, such that the control unit, first speaker unit and bottom speaker unit are in an attached configuration. The bottom speaker unit also may include a wheel assembly engageable with a ground surface so as to allow rolling movement of the control unit, first speaker unit and bottom speaker unit in the attached configuration.

In one embodiment of the present invention, the control unit and the first speaker unit may include locating guides associated on bottom ends of the control unit and first speaker unit. The locating guides may be integrally formed on the control unit and first speaker unit. The locating guides of the control unit may align and fit on a panel recess of the first speaker unit, and the locating guides of the first speaker unit may align and fit on a panel recess of a bottom speaker unit.

In one embodiment of the present invention, the attachment mechanism may be latch members associated on audio equipment. The latch members may be integral with the audio equipment. The latch members may be configured so as to engage and releasably lock with each other, allowing attachment of the audio equipment.

In one embodiment of the present invention, an apparatus for attaching audio equipment includes at least one control unit. The control unit may have a handle attached on a back of the control unit and positioned towards a top end of the control unit. A pair of latch members may be oppositely disposed on sides of the control unit and positioned towards a bottom end of the control unit. The apparatus further includes a plurality of speaker units. At least one of the speaker units may be a first speaker unit, and may have at least a first pair of latch members and a second pair of latch members, each pair being oppositely disposed on sides of the first speaker unit. The first pair of latch members may be positioned towards a top end of the first speaker unit. The second pair of latch members may be positioned towards a bottom end of the first speaker unit. Of the plurality of speaker units, one speaker unit may be a bottom speaker unit. The bottom speaker unit may have at least one pair of latch members oppositely disposed on sides of the bottom speaker unit and positioned towards a top end. The latch members of the control unit may engage and releasably lock with the first pair of latch members of the first speaker unit, and the second latch members of the first speaker unit may engage and releasably lock the pair of latch members of the bottom speaker unit, such that the control unit, first speaker unit and the bottom speaker unit are in an attached configuration. The bottom speaker unit also may include a wheel assembly engageable with a ground surface so as to allow rolling movement of the control unit and plurality of speaker units in the attached configuration.

In one embodiment of the present invention, the control unit, and the plurality of speaker units may be attached by latching members in a stacked configuration. The speaker units may include a bottom speaker having a wheel assembly allowing transport of the control unit and the speaker units in an attached configuration.

In one embodiment, the plurality of speaker units may be stacked such that audio output ends of the speaker units may be coupled face to face with each other.

In another embodiment of the present invention, each pair of latch members may be both defined as male latch members, or female latch members. A control unit may include a pair of latch members both defined as male latch members, or female latch members. The pair of latch members of the control unit may engage and releasably lock with a first speaker unit including a first pair of latch members oppositely configured to that of the control unit, and both defined as male latch members or female latch members. The first speaker unit may include a second pair of latch members both defined as male latch members or female latch members. The second pair of latch members may engage and releasably lock with a bottom speaker unit having a pair of latch members oppositely configured to that of the second pair of latch members of the first speaker unit, and both defined as male latch members or female latch members. Male latch members may engage and releasably lock with female latch members in attaching the control unit, first speaker, and bottom speaker.

In another embodiment of the present invention, each pair of latch members may be defined as male latch members or female latch members. A control unit may include a pair of latch members defined as one female latch member and one male latch member. The pair of latch members of the control unit may engage and releasably lock with a first speaker unit including a first pair of latch members oppositely configured to that of the latch members of the control unit, and defined as one male latch member and one female latch member. The male latch member and female latch member of the control unit may engage and releasably lock with the female latch member and the male latch member of the first speaker unit, respectively. The first speaker unit may include a second pair of latch members defined as one male latch member and one female latch member. The second pair of latch members may engage and releasably lock a bottom speaker unit having a pair of latch members oppositely configured to that of the second pair of latch members of the first speaker unit, and defined as one male latch member and one female latch member. The male latch member and the female latch member of the second pair of latch members of the first speaker unit may engage and releasably lock with the female latch member and the male latch member of the bottom speaker unit, respectively.

In another embodiment of the present invention more than two speaker units may be attached for transport.

In one embodiment of the present invention, a method of attaching audio equipment includes providing a plurality of audio components. Each of the audio components may include at least one attachment mechanism, such that the attachment mechanisms may be integral with each audio component. At least one of the audio components may include at least one handle attached and integrally formed on the audio component. Also, at least one of the audio components may include a wheel assembly associated on and integral with the audio component. The audio components may be located together using locating guides associated and integral with the audio components. The audio components may be attached using the attachment mechanisms integral with the audio components. The audio components may be releasably locked together in an attached configuration.

In one embodiment of the present invention, a method of attaching audio equipment includes stacking the audio components in a vertical orientation.

In one embodiment of the present invention, a method of attaching audio equipment includes coupling audio output ends of the audio components, such that the audio output ends may be coupled face to face with each other.

In one embodiment of the present invention, a method of attaching audio equipment includes attaching accessory equipment to the audio components in an attached configuration.

The present invention provides the advantage of a system that can transport audio equipment in a convenient manner. The attachment mechanisms, handle, wheels and locating guides of the attached audio equipment components allow for an attached and secured package to move around and easily be separated. The built-in or integral attachment and transport features minimize the requirement for an excessive number of parts to pack and transport the audio equipment. The need for rack cases, covers, bags, and boxes may be eliminated thereby reducing costs and risk of losing such extra parts.

These and other various advantages and features of novelty, which characterize the invention, are pointed out in the following detailed description. For better understanding of the invention, its advantages, and the objects obtained by its use, reference should also be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 represents a front view of one embodiment of attached audio equipment in accordance with the principles of the present invention.

FIG. 2 represents a rear view of the attached audio equipment of FIG. 1.

FIG. 3 represents a first side view of the attached audio equipment of FIG. 1.

FIG. 4 represents a second side view of the attached audio equipment of FIG. 1.

FIG. 5 represents a side schematic view of one embodiment of a method of attaching audio equipment in accordance with the principles of the present invention.

FIG. 6 represents a schematic view of one embodiment of attachment mechanisms in accordance with the principles of the present invention.

FIG. 7 represents a schematic view of one embodiment of attachment mechanisms in accordance with the principles of the present invention.

FIG. 8 represents a plan view of one embodiment of locating guides and a recess panel in accordance with the principles of the present invention.

FIG. 9 represents a schematic view of one embodiment of transporting attached audio equipment.

FIG. 10 represents a plan view of one embodiment of a control panel in accordance with the principles of the present invention.

FIG. 11 represents a plan view of one embodiment of a method for attaching accessory equipment to attached audio equipment system.

FIG. 12 represents a top plan view of the method of FIG. 10.

FIG. 13 represents a side plan view of the method of FIG. 10

FIG. 14 represents one embodiment of the audio equipment in use in accordance with the principles of the present invention.

### DETAILED DESCRIPTION OF THE PREFERRED EMBODIMENT

In the following description of various illustrated embodiments, reference is made to the accompanying drawings that form a part hereof, and in which is shown by way of illustration of the embodiments in which the invention may be practiced. It is to be understood that other embodiments may be utilized as structural changes may be made without departing from the spirit and scope of the present invention.

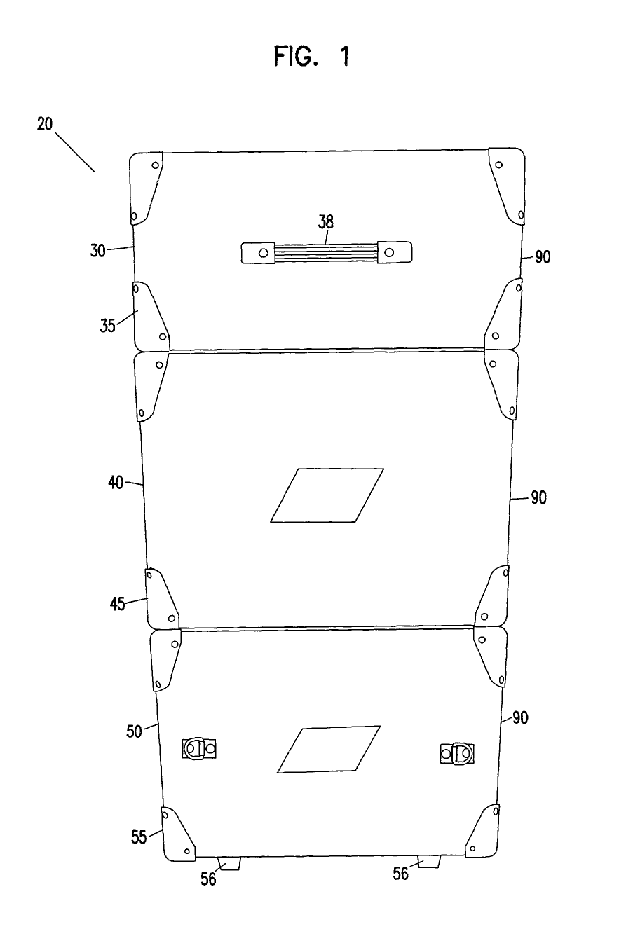

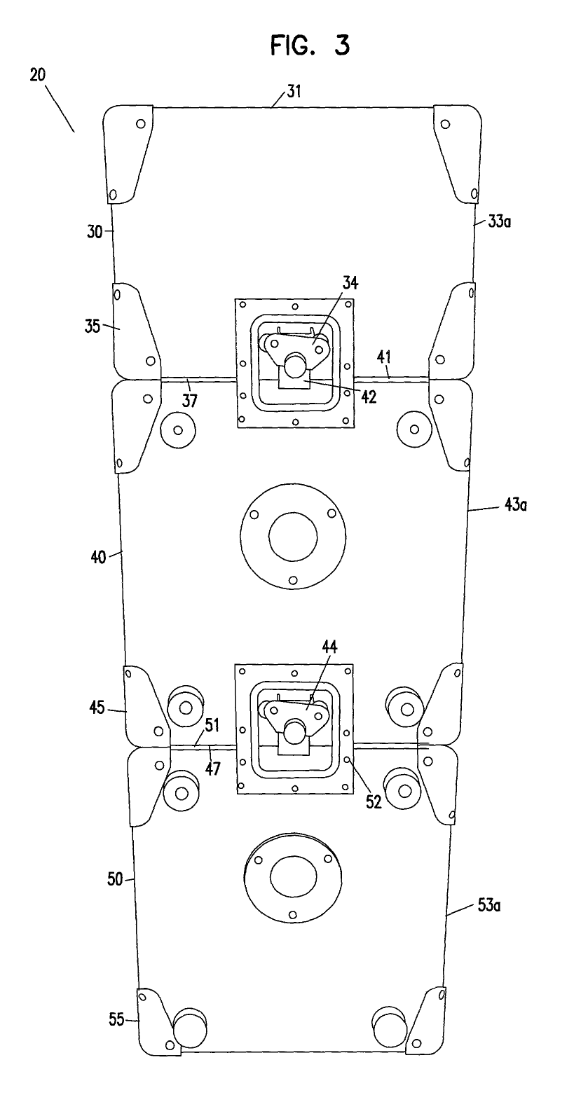

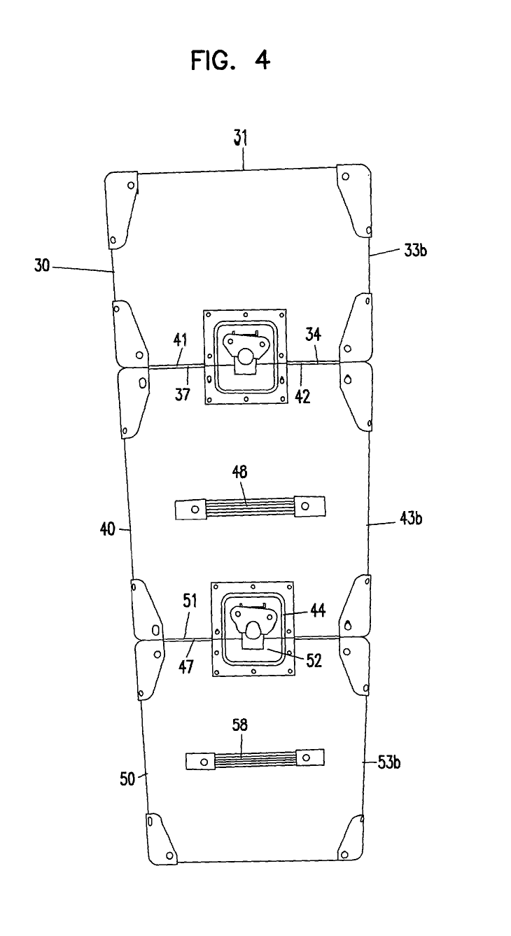

In accordance with principles of the present invention, FIGS. 1-4 illustrate one embodiment for an apparatus 20 for transporting audio equipment that includes a plurality of audio components. The audio components 30, 40, and 50 each may have at least one attachment mechanism, such that the attachment mechanisms may be integral with each audio component. At least one of the audio components includes at least one handle 36 associated thereon and integrally formed on the audio component. At least one of the audio components includes at least one wheel assembly 59 associated thereon and integral with the audio component. The attachment mechanisms, handle, and wheel assembly may allow the audio components to stack in a vertical orientation and be transported as a single unit, apparatus 20, in an attached configuration.

FIGS. 1-4 illustrate an apparatus 20 including audio equipment in an attached configuration. The audio equipment includes a plurality of audio components including a control unit 30, a first speaker unit 40 and a bottom speaker unit 50. The control unit 30 may have a handle 36 integrally formed on the control unit 30. The handle 36 may be disposed at a back 39 of the control unit 30 and positioned towards a top end 31 of the control unit 30. The audio components may include attachment mechanisms that may be latch members. It will be appreciated that other attachment mechanisms may be employed such as tongue and groove fittings, or a combination of latch members and tongue and groove fittings. For descriptive purposes, latch members are illustrated in the figures and are provided as one example of an attachment mechanism. The control unit 30 may include a pair of latch members 34. The latch members 34 may be oppositely disposed on sides 33a, 33b of the control unit 30. The latch members 34 may be positioned towards a bottom end 37 of the control unit. The first speaker unit 40 may include a first pair of latch members 42 and a second pair of latch members 44. The first pair of latch members 42 may be oppositely disposed on sides 43a, 43b of the first speaker unit 40. The first pair of latch members 42 may be positioned at a top end 41 of the first speaker unit 40. The second pair of latch members 44 may be oppositely disposed on sides 43a, 43b of the first speaker unit 40, and positioned at a bottom end 47 of the first speaker unit 40. The bottom speaker unit 50 may include a pair of latch members 52. The pair of latch members may be oppositely disposed on sides 53a, 53b, and positioned towards a top end 51 of the bottom speaker unit 50.

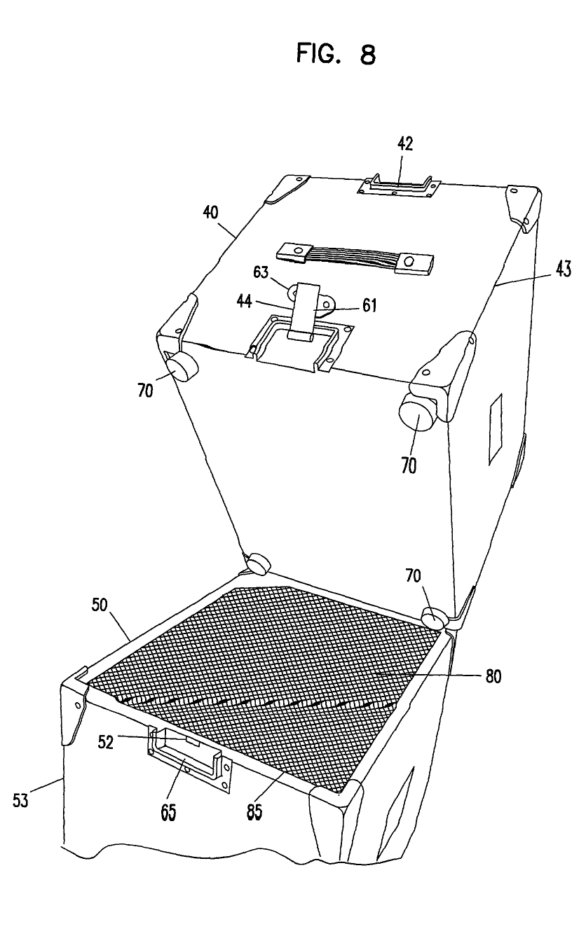

The latch members of the control unit, first speaker unit, and bottom speaker unit, may include male latch portions 61 and 63 and a female receiving lock portion 65 (best shown in FIG. 8). The male latch portions may be spring loaded such that the attached audio equipment does not rattle. The latch members 34 of the control unit 30 may engage and releasably lock with the first pair of latch members 42 of the first speaker unit 40, and the second pair of latch members 44 of the first speaker unit 40 may engage and releasably lock with the pair of latch members 52 of the bottom speaker unit 50, such that the control unit 30, first speaker unit 40 and bottom speaker unit 50 are in an attached configuration. The latch members of the first speaker unit and the bottom speaker unit also may include male latch portions 61, 63 and a female receiving latch portion 65. The bottom speaker unit 50 also may include at least one wheel assembly 59 engageable with a ground surface so as to allow rolling movement of the control unit 30, first speaker unit 40 and bottom speaker unit 50 in the attached configuration. The wheel assembly 59 may be mounted on skids 54 of the bottom speaker 50. Feet portions 56 are included on the bottom speaker unit so as to keep the apparatus 20 from tilting over when the apparatus 20 is at rest or in storage.

Handles 38, 48, and 58 of the control unit 30, first speaker unit 40, and the bottom speaker unit 50, respectively, may be included so as to allow ease of handling during set up or use. The handles 38, 48, and 58 may be strap handles. The outer surfaces of the control unit 30, first speaker unit 40, and bottom speaker unit 50 may be covered in a carpet material 90 so as to protect and maintain durability of the audio equipment during transportation, storage, and use. Furthermore, the control unit 30, first speaker unit 40, and bottom speaker unit 50 may include a protective material 34, 45, and 55 at corners of the units. The protective material may be, but is not limited to, a plastic or rubber material.

It will be appreciated that the attachment mechanisms including latch members, handles, and wheel assembly may be integral with the audio equipment they are disposed on. Further, the attached audio equipment may be stacked in a vertically attached configuration.

As shown in FIGS. 1-4, oppositely disposed pairs of latch members for the control unit 30, first speaker unit 40, and bottom speaker unit 50 are configured such that each pair has a latch portion 61 being a male portion, or each pair has a receiving lock portion 65 being a female portion. However, it will be appreciated that other configurations may be employed.

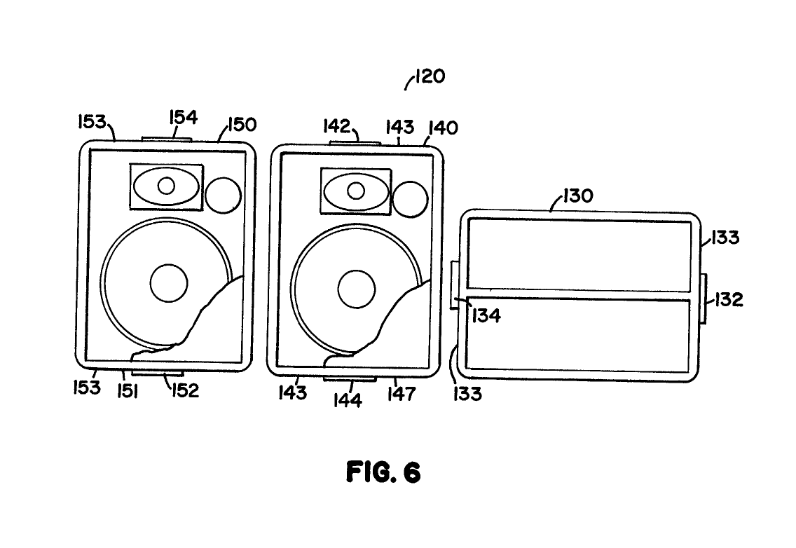

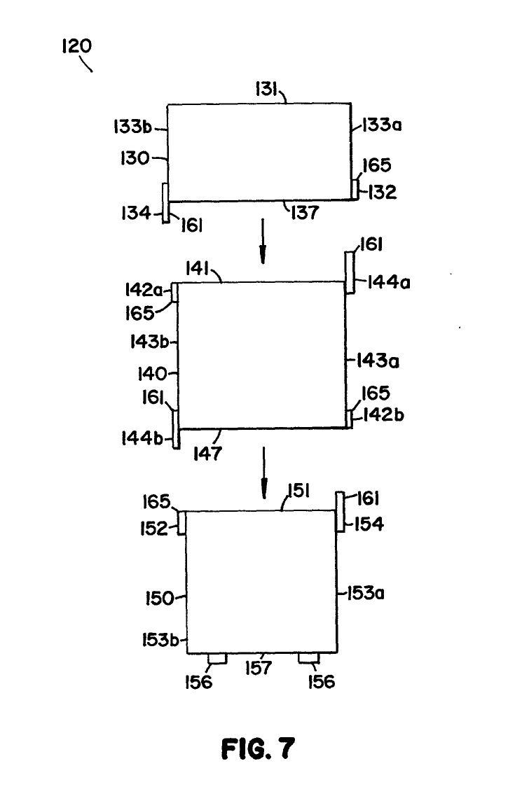

For example, FIGS. 6 and 7 illustrate another embodiment for latch members. A bottom speaker unit 150 includes latch members 152, 154 oppositely disposed on sides 153a, 153b of the bottom speaker unit. The latch members 152, 154 are positioned towards a top end 151. As shown in FIG. 6, latch member 152 may be a female latch member, and latch member 154 may be a male latch member. Further, a first speaker unit 140 includes a second pair of latch members 142b, 144b. The first pair of latch members 142a, 144a are shown in FIG. 7. Latch members 142b, 144b may be oppositely disposed on sides 143a, 143b, and positioned towards a bottom end 147 of the first speaker unit 147. Latch member 142b may be a female latch member so as to engage and releasably lock with male latch member 154 of the bottom speaker unit 150. Latch member 144b may be a male latch member, so as to engage and releasably lock with female latch member 152 of the bottom speaker unit 150. The control unit 130 includes a pair of latch members 132 and 134 oppositely disposed on sides 133 of the control unit 130. Latch member 132 may be a female latch member, and latch member 134 may be a male latch member. Latch members 132, 134 may engage and releasably lock with male latch member 144a, and female latch member 142a, respectively (shown in FIG. 7)

FIG. 7 illustrates a configuration of latch members for attaching the control unit 130, first speaker unit 140, and bottom speaker unit 150. The control unit 130 is shown having male latch member 134 and female latch member 132. The latch members 132, 134 may be engaged and releasably locked with the first pair of latch members 144a, 142a of the first speaker unit 140, respectively. Latch members 142a, 144a of the first speaker unit 140 are shown as being oppositely configured to that of the latch members 132, 134 of the control unit 130, so that a latch portion 161 may engage and releasably lock a receiving lock portion 165. Similar to the above, the second pair of latch members 142b, 144b of the first speaker unit 140 may engage and releasably lock with latch members 154, 152 of the bottom speaker unit 150, respectively. The alternating arrangement of the latch members in the control unit 130, first speaker unit 140, and bottom speaker unit 150 assures proper orientation of the units when connecting and locking them together for transport or storage. Wheel assembly 159 enable the apparatus 120 to be transported, feet portions 156 prevent the apparatus 120 from tilting over when standing at rest or in storage. However, this configuration is merely exemplary as other arrangements may be employed. For instance, alternate tongue and groove fittings may also be employed, or a configuration employing latch members and tongue and groove fittings may be employed.

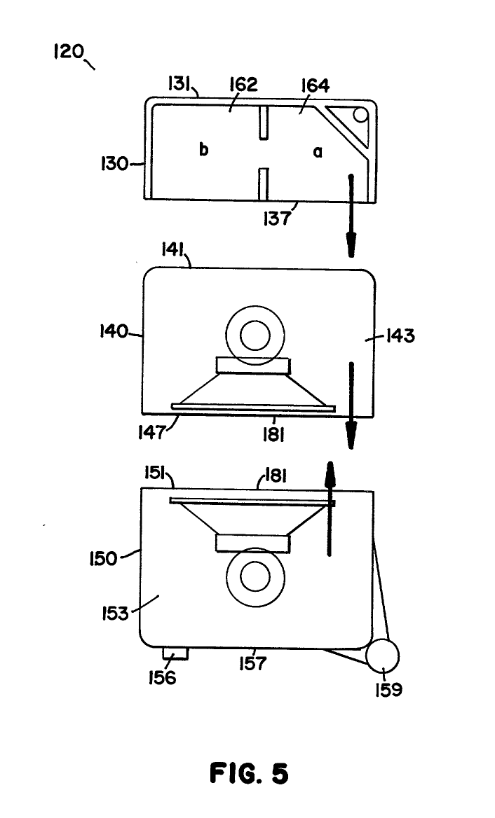

FIG. 5 illustrates an embodiment for connecting the first speaker unit 140 with the bottom speaker unit 150. FIG. 5 shows the audio output sides 181 of the speaker units facing each other, and to be coupled together facing each other (indicated by arrows). With the speaker units facing each other at their audio output sides, the speakers and components therein may be protected from damage and moisture entry.

FIG. 8 illustrates an embodiment for locating guides 70. The locating guides 70 are shown on each corner on the bottom end 47 of the first speaker unit 40. The locating guides 70 may contact with a recessed surface 85 having a lip portion 80 of the bottom speaker unit 50. When the first speaker unit 40 is connected with the bottom speaker unit 50 for attachment, the locating guides 70 may fit with the recessed surface 85 and lip portion 80. The locating guides provide alignment of the units and may prevent sliding between the units. Locating guides also may be included on the control unit 30, in a similar manner as in the first speaker unit 40 above, so as to assure proper alignment between the first speaker unit 40 and the control unit 30. It will be appreciated that the locating guides may be integral with the audio equipment they are disposed on.

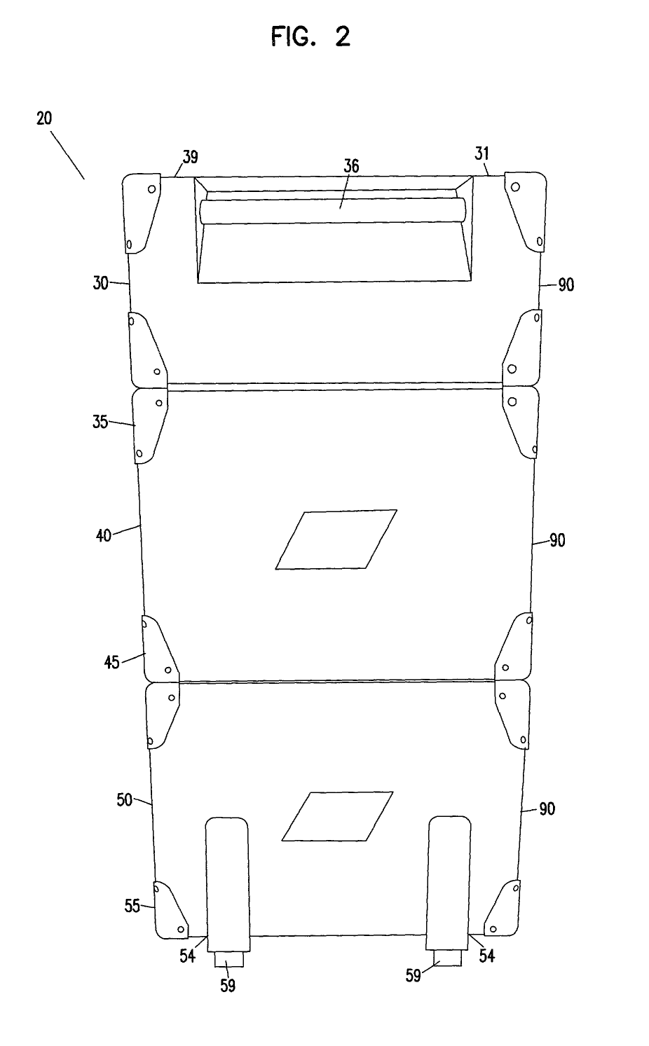

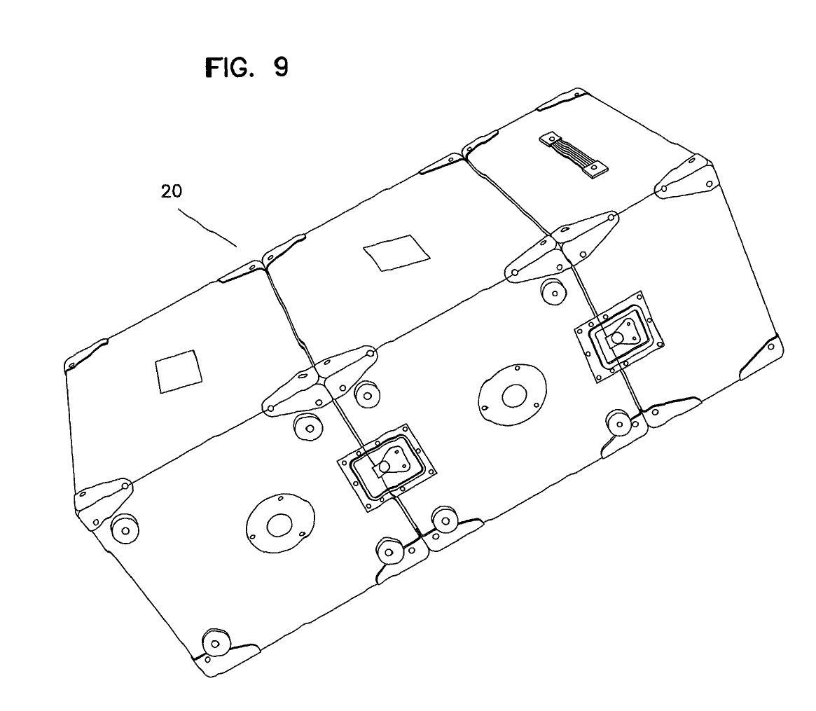

FIG. 9 illustrates one embodiment of the apparatus 20 being transported. The apparatus may be tilted, as shown in FIG. 9, so that the wheel assembly 59 may engage the ground, while using the handle 36 to hold and balance the apparatus 20. The wheel assembly and handle are best shown in FIG. 2. The handle may be integrally formed on the control unit, or other suitable portion of the apparatus 20. The apparatus 20 may be rolled to a desired destination for use, storage or further transportation such as in a vehicle.

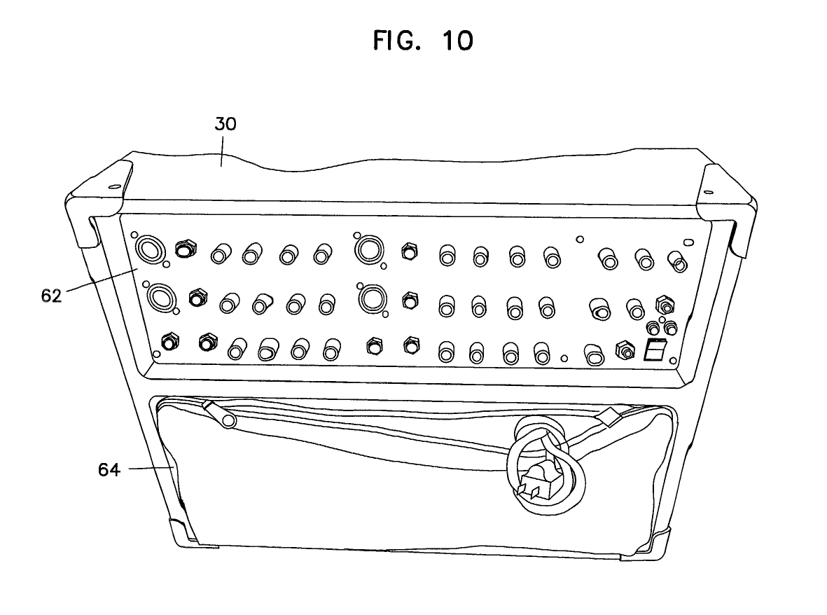

FIG. 10 illustrates a preferred embodiment for a control unit 30. The control unit is illustrated as having two compartments 62, 64. Compartment 62 may be provided with the electronic components of the control unit 30 while the compartment 64 may allow for an inner storage compartment to retain other accessories. Examples of such accessories may include cables, microphones, etc.

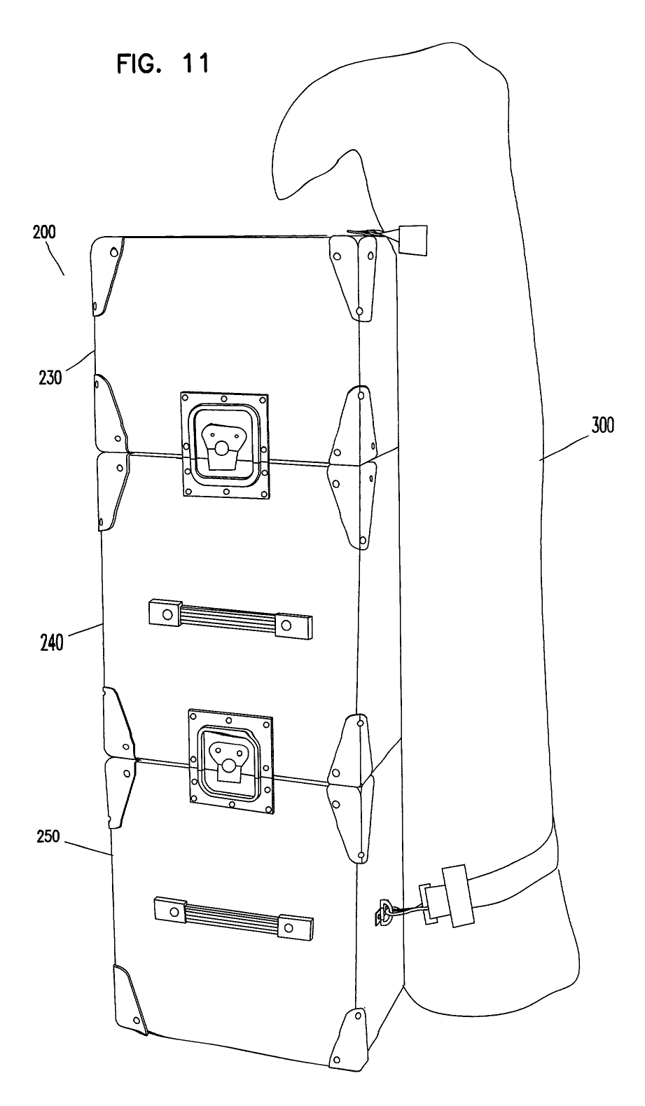

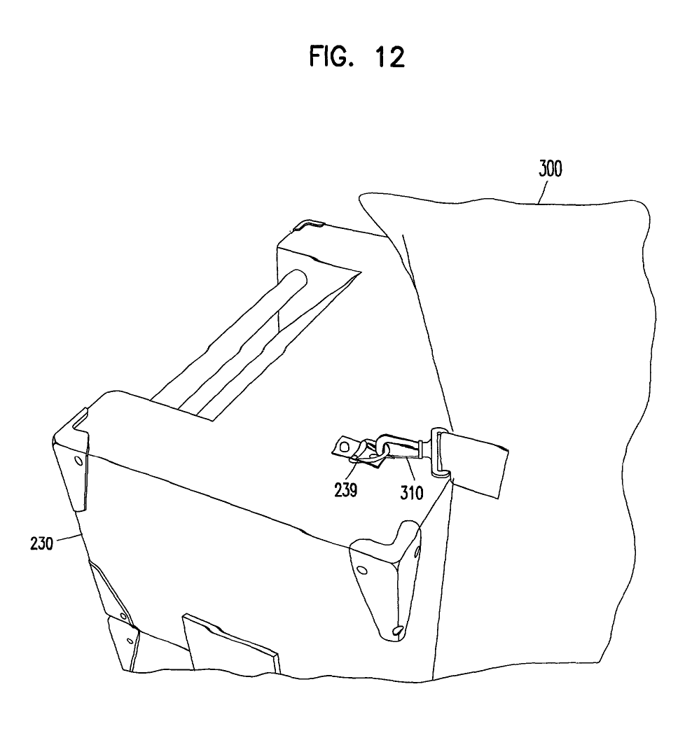

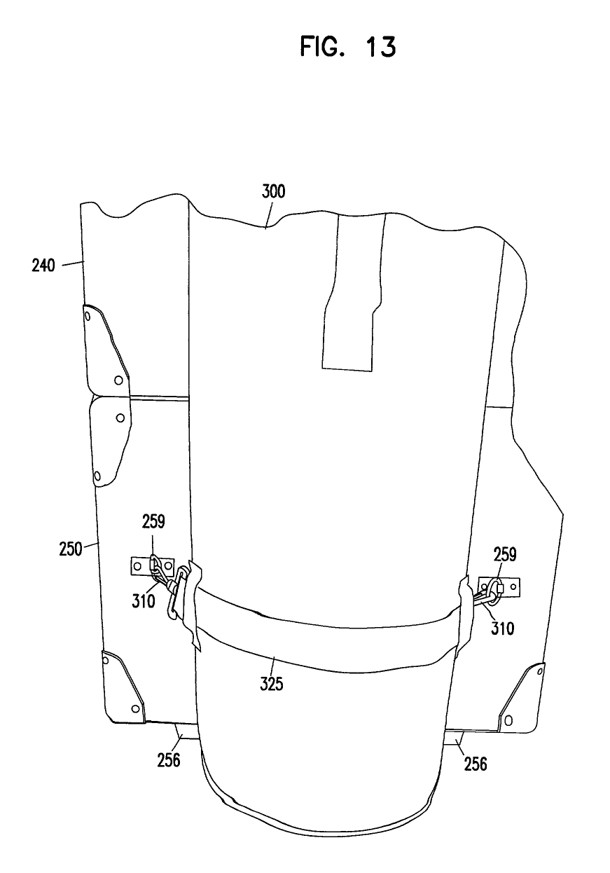

FIGS. 11-13 illustrate an embodiment for attaching accessory units 300 to the apparatus 200. FIG. 13 shows an accessory unit 300 attached to an apparatus 200 including a control unit 230, first speaker unit 240, and a bottom speaker unit 250 in an attached configuration. The bottom speaker unit 250 may also include feet portions 256 disposed at the bottom of the speaker unit 250. FIG. 12 shows a loop portion 239 on the control unit 230 engaged and releasably locked with a hook portion 310. FIG. 13 illustrates loop portions 259 disposed on the bottom speaker 250 engaged and releasably locked with hook portions 310 of the accessory unit 300. A strap 325 retains the hook portions 310, and may be affixed to the accessory unit 300 so as to attach and retain the accessory unit 300 to the apparatus 200. The loop and hook portions illustrated are merely exemplary as other means of attaching an accessory unit also may be employed.

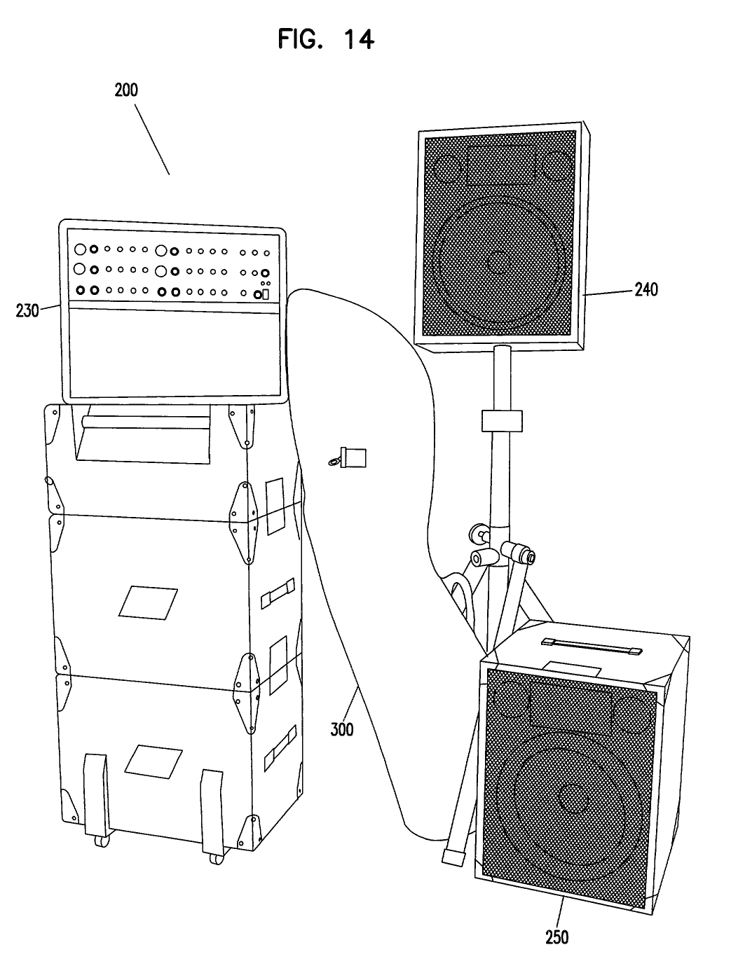

FIG. 14 illustrates the apparatus 200 in both its attached state and in an unpacked state, set up for use.

As discussed above, the present invention provides the advantage of a system that can transport audio equipment in a convenient manner. The handle, latches, wheels and locating guides of the attached system allows for an attached and secured package to move around and easily be separated. The built in latch and attachment features may be integral with the audio equipment they are disposed on, thereby minimizing the requirement for an excessive number of parts to pack and transport the audio equipment. The need for rack cases, covers, bags, and boxes may be eliminated thereby reducing costs and risk of losing such extra parts.

Having described the embodiments of the present invention, modifications and equivalents may occur to one skilled in the art. It is intended that such modifications and equivalents shall be included with the scope of the invention.

We claim:

1. An apparatus for transporting audio equipment comprising:
a plurality of audio components, each of the audio components including at least one attachment mechanism;
at least one of the audio components including at least one handle;
one of the audio components including a wheel;
the audio components being releasably attachable end for end in a stacked arrangement by their respective attachment mechanisms;
the wheel assembly supporting the audio components during transport in the stacked arrangement.

2. An apparatus for transporting audio equipment comprising:
a control unit, and a plurality of speaker units;
the control unit having a handle attached on the control unit, the control unit including an attachment mechanism;
at least one of the speaker units being a first speaker unit including a first attachment mechanism and a second attachment mechanism;
one of the speaker units being a bottom speaker unit including an attachment mechanism;
the attachment mechanism of the control unit being engageble so as to releasably lock with the first attachment mechanism of the first speaker unit, and the second attachment mechanism of the first speaker unit being engageable so as to releasably lock with the attachment mechanism of the bottom speaker unit, such that the control unit, first speaker unit and bottom speaker unit are in an attached configuration;
the bottom speaker unit including a wheel assembly engageable with a ground surface so as to allow rolling movement of the control unit, first speaker unit and bottom speaker unit in the attached configuration.

3. An apparatus according to claim 2, wherein the attachment mechanisms of each of the control unit, the first speaker unit, and the bottom speaker unit comprise a plurality of latch member pairs integral with the control unit, first speaker unit, and bottom speaker unit.

4. An apparatus according to claim 2, wherein the control unit and the first speaker unit each include a plurality of locating guides associated on bottom ends of the control unit and the first speaker unit.

5. An apparatus according to claim 4, wherein the locating guides of the control unit align and fit on a panel recess of the first speaker unit.

6. An apparatus according to claim 4, wherein the locating guides of the first speaker unit align and fit on a panel recess of the bottom speaker unit.

7. An apparatus according to claim 3, wherein the latch member pair of the control unit being oppositely disposed on sides of the control unit, and positioned toward a bottom end, and the latch member pair of the control unit being both male latch members or female latch members.

8. An apparatus according to claim 3, wherein the first speaker unit comprises a first latch member pair of the first speaker unit being oppositely disposed on sides of the first speaker unit, and positioned toward a top end; and a second latch member pair of the first speaker unit being oppositely disposed on the sides of the first speaker unit, and positioned toward a bottom end, the first latch member pair both being male latch members or female latch members, and the second latch member pair both being male latch members or female latch members.

9. An apparatus according to claim 3, wherein the latch member pair of the bottom speaker unit being oppositely disposed on sides of the bottom speaker unit, and positioned toward a top end, and the latch member pair of the bottom speaker both being male latch members or female latch members.

10. An apparatus according to claim 2, wherein the control unit, first speaker unit, and bottom speaker unit are stacked in a vertical orientation when in the attached configuration.

11. An apparatus according to claim 2, wherein the first speaker unit and the bottom speaker unit include audio output sides in facing relation to each other when in the attached configuration.

12. An apparatus according to claim 2, wherein the attachment mechanism of the control unit being one of a male latch member and one of a female latch member.

13. An apparatus according to claim 2, wherein the first attachment mechanism of the first speaker unit being one of a male latch member and one of a female latch member.

14. An apparatus according to claim 2, wherein the second attachment mechanism first speaker unit being one of a male latch member and one of a female latch member.

15. An apparatus according to claim 2, wherein the attachment mechanism of the bottom speaker unit being one of a male latch member and one of a female latch member.

16. A method of attaching audio equipment comprising:
providing a plurality of audio components, each of the audio components including at least one attachment mechanism; at least one of the audio components including at least one handle; one of the audio components including a wheel; the audio components being releasably attachable end for end in a stacked arrangement by their respective attachment mechanisms; the wheel assembly supporting the audio components during transport in the stacked arrangement.;
locating the audio components together using locating guides associated and integral with the audio components.
attaching the audio components using the attachment mechanisms so as to releasably lock the audio components together in an attached configuration.

17. The method according to claim 16, wherein locating the audio components includes stacking the audio components in a vertical orientation.

18. The method according to claim 16, wherein locating the audio components includes coupling audio output sides of the audio components such that the audio output sides are coupled face to face with each other.

19. The method according to claim 16, comprising attaching accessory equipment to the audio components in the attached configuration.
